(19) United States
(12) Patent Application Publication
(10) Pub. No.: US 2011/0010250 A1
(43) Pub. Date: Jan. 13, 2011

(54) Method and system for tracking and sending advertisements printed on the interior of shipping containers

(75) Inventors: Edward J. Brooks, Sunnyside, NY (US); Richard Chan, Sunnyside, NY (US)

Correspondence Address: Edward;Chin, 20 Monroe Street LE-6, New York, NY, 10002, US

(73) Assignee: BRANDILLA HOLDINGS LLC, Sunnyside, NY (US)

(21) Appl. No.: 12/502,170

(22) Filed: Jul. 13, 2009

(51) Int. Cl. G06Q 30/00; G06Q 90/00; G06Q 50/00

(52) U.S. Cl. 705/14.69; 705/500

(57) ABSTRACT

Disclosed is a system and method for sending and tracking printed advertisements. The method includes receiving an advertisement order to disseminate an advertisement message from an advertiser, sending a printing order to print a design on a wall of a shipping container, wherein the design includes the advertisement message and a unique identification code linked to the advertisement message; sending the shipping container to an item seller, instructing the item seller to configure the shipping container such that the design appears on an inside wall of the shipping container, and further instructing the item seller to submit destination information, the unique identification code, and origination information of the shipping container, sending an item to a destination using the shipping container, receiving the destination information, the unique identification code, and the origination information from the item seller, compensating the item seller upon receiving the destination information, the unique identification code, and the origination information submitted by the item seller, and providing a report of at least the destination information, the advertisement message, and the origination information to the advertiser.

### BACKGROUND

Booksellers are extremely cost-sensitive when doing business. They will try to minimize all costs when selling their inventory. In the past, in order to save money, booksellers would go to their local United States Post Office to obtain free boxes that the Post Office provides. The booksellers would then repurpose the boxes so that the Post Office's logos do not appear on the boxes and then use the repurposed boxes to ship their books. The Post Office boxes proved to be acceptable shipping containers because of their size, structure, and sturdy construction.

The Post Office boxes have the Post Office's writing and printing on the outside of the boxes, which prevents people from using the unaltered boxes. A person using an unaltered Post Office box will be charged, by the Post Office, a certain premium rate for using the box by the Post Office. In order to avoid this extra charge, the booksellers would alter the boxes so that the Post Office's printed logo would not appear on the box. The repurposed Post Office box would not be detected by the Post Office as a Post Office box. This way, book sellers may pay a low rate to ship their items to their customers.

This practice of using Post Office boxes has become so widespread that the Post Office noted some significant financial losses due to the unaccounted booksellers' usage of their boxes. In response to this practice, the Post Office placed “discard if seen” notifications on their boxes (which would appear if the boxes were used inappropriately), which resulted in the repurposed boxes (and their contents) to be discarded by the Post Office. When discarded, the customers of the books never receive their books. Undelivered books resulted in at least either negative reviews or additional costs for the booksellers.

Now, because the free way to obtain shipping containers from the Post Office is no longer effective or available, to continue shipping books, booksellers either have to increase the cost of shipping books to include the cost of purchasing shipping containers or to use lower quality shipping containers. In order for the book sellers to use high quality shipping containers, the book sellers must purchase new cardboard boxes. However, instead of using the boxes, booksellers typically use bubble wrap and masking tape to wrap and ship their packages. As a result of this alternative, some books are not adequately protected, resulting in damaged books. When the damaged books are received by the customers, the customers give negative reviews to the booksellers.

### SUMMARY OF THE INVENTION

Disclosed is a method for sending and tracking printed advertisements. The method includes receiving an advertisement order to disseminate an advertisement message from an advertiser, sending a printing order to print a design on a wall of a shipping container, wherein the design includes the advertisement message and a unique identification code linked to the advertisement message; sending the shipping container to an item seller, instructing the item seller to configure the shipping container such that the design appears on an inside wall of the shipping container, and further instructing the item seller to submit destination information, the unique identification code, and origination information of the shipping container, sending an item to a destination using the shipping container, receiving the destination information, the unique identification code, and the origination information from the item seller, compensating the item seller upon receiving the destination information, the unique identification code, and the origination information submitted by the item seller, and providing a report of at least the destination information, the advertisement message, and the origination information to the advertiser.

Also disclosed is a system for sending and tracking printed advertisements, the system including a receiving section for receiving an advertisement order to disseminate an advertisement message from an advertiser, a sending section for sending a printing order to print a design on a wall of a shipping container, wherein the design includes the advertisement message and a unique identification code linked to the advertisement message, wherein the sending section further sends the shipping container to an item seller, an instructing section for instructing the item seller to configure the shipping container such that the design appears on an inside wall of the shipping container, and further instructing the item seller to submit destination information, the unique identification code, and origination information of the shipping container, the receiving section further receiving the destination information, the unique identification code, and the origination information from the item seller, a compensating section for paying the item seller upon receiving the destination information, the unique identification code, and the origination information submitted by the item seller, and a reporting section for providing a report of at least the destination information, the advertisement message, and the origination information to the advertiser.

Also disclosed is a computer readable medium containing instructions causing a computer to receive an advertisement order to disseminate an advertisement message from an advertiser, send a printing order to print a design on a wall of a shipping container, wherein the design includes the advertisement message and a unique identification code linked to the advertisement message, send the shipping container to an item seller, instruct the item seller to configure the shipping container such that the design appears on an inside wall of the shipping container, and further instruct the item seller to submit destination information, the unique identification code, and origination information of the shipping container, send an item to a destination using the shipping container, receive the destination information, the unique identification code, and the origination information from the item seller, compensate the item seller upon receiving the destination information, the unique identification code, and the origination information submitted by the item seller; and provide a report of at least the destination information, the advertisement message, and the origination information to the advertiser.

### BRIEF DESCRIPTION OF THE DRAWINGS

FIG. 1. shows the unassembled shipping container having examples of printed designs on its panels.

FIG. 2. shows the partially assembled shipping container having examples of printed designs on the interior of the container.

FIG. 3. shows the printed designs having different components.

FIG. 4. shows examples of information of origination, destination, and printed materials.

FIG. 5. shows a flowchart diagram of shipping and tracking system.

FIG. 6. shows a flowchart diagram of sellers' incentive system.

FIG. 7. shows a network diagram of electronic system with enumerated features.

### DETAILED DESCRIPTION OF THE DRAWINGS

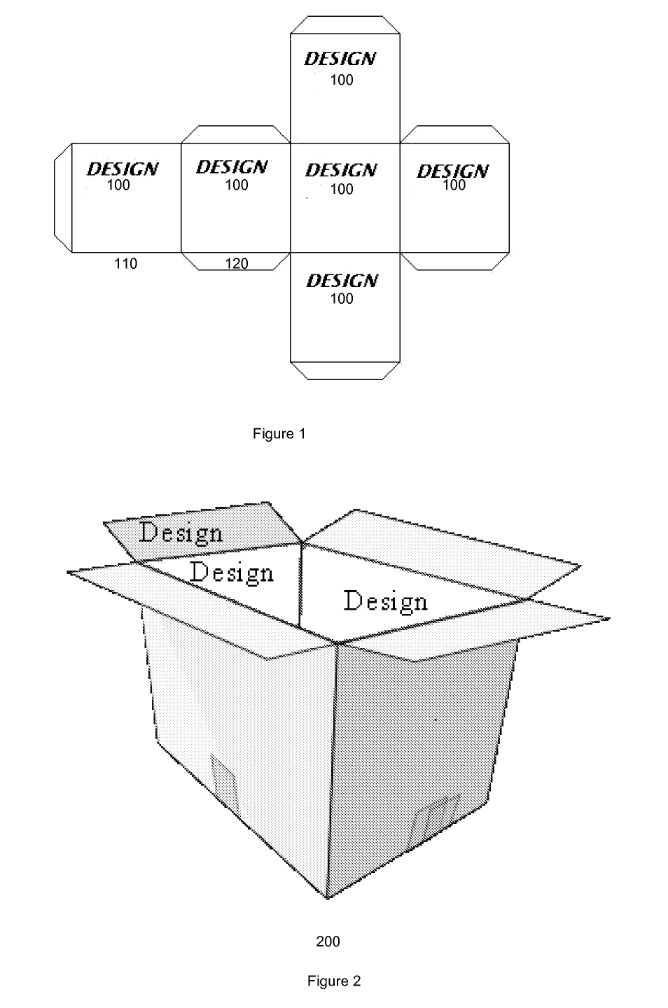

FIG. 1 shows an unassembled shipping container 110 with designs 100 printed on the panels of the shipping container 110. Assembly flaps 120 may also have a design printed therein. Such printed designs 100 are provided to a printer, who may manufacture, print, and generate unassembled shipping containers 110 having designs 100 therein. The unassembled shipping containers may be manufactured to have pre-folded folds or creases such that there is a recommended way to assemble the shipping container. The folds may be perforated or partially cut to ease the folding. The printed shipping containers may be printed in a way such that the printed designs will appear either on the inside or the outside of the shipping container, should the shipping container be assembled according to the recommendations. In a preferred embodiment, the shipping containers may have instructions on how to properly assemble the shipping containers. The printed instructions may be printed on the flaps 120 or on the panels along with the designs 100 such that there are outlines of where the panels or assembly parts should fit.

The shipping containers may also have slots or tabs that encourage proper construction and/or to provide additional structural integrity to the container. The flaps 120 may have adhesives so as to enable and encourage proper assembly. The printed panels may contain additional padding or cushioning materials only on the side interfacing with the items/materials to be shipped.

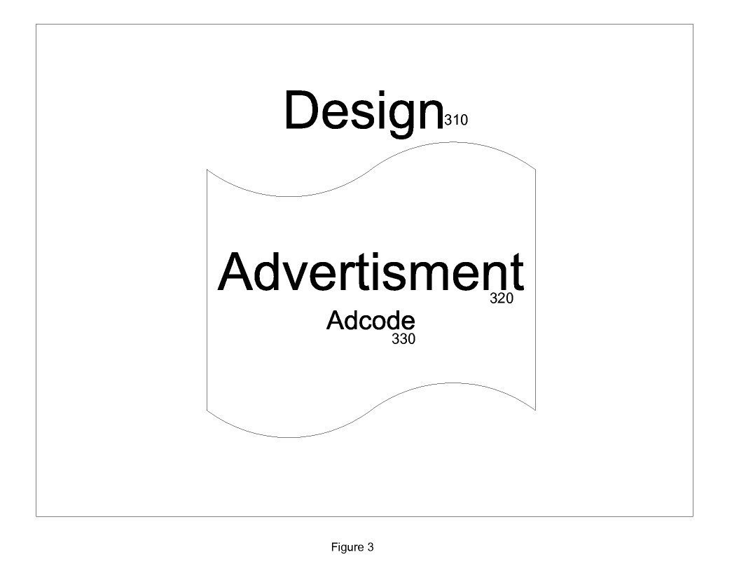

FIG. 2 shows a shipping container 200 that is partially assembled. The shipping container 200 may be assembled so that the printed sides appear on the insides of the container. Once the shipping container is fully assembled, the designs are to be viewable once the container is opened. The designs are not viewable from the outside when the container is assembled and sealed. The shipping containers may have pre-folded folds or creases and the printed sides may or may not appear on the insides of the shipping container if it was assembled according to the folds/creases. The assembly instructions indicate that the shipping containers must be assembled such that the printed materials appear on the inside walls of the shipping container.

Once assembled, the shipping container 200 may include, on an outside panel, a place to indicate the final destination of the package. The shipping container may also include a place to indicate origination information of the package. The package may provide structural integrity to protect its contents as well as to facilitate shipping and handling. For example, the box may be sized such that a mail handler may easily grip the shipping container. Also, in a preferred embodiment, the shipping container may be a rectangular shape such that shifting and rolling of the container during shipping would be minimized and the integrity of the box would be maximally protected. In embodiments, shipping containers may come one standard size or a variety of sizes. For example, one particular size may conform to an average size of printed and/or bounded books.

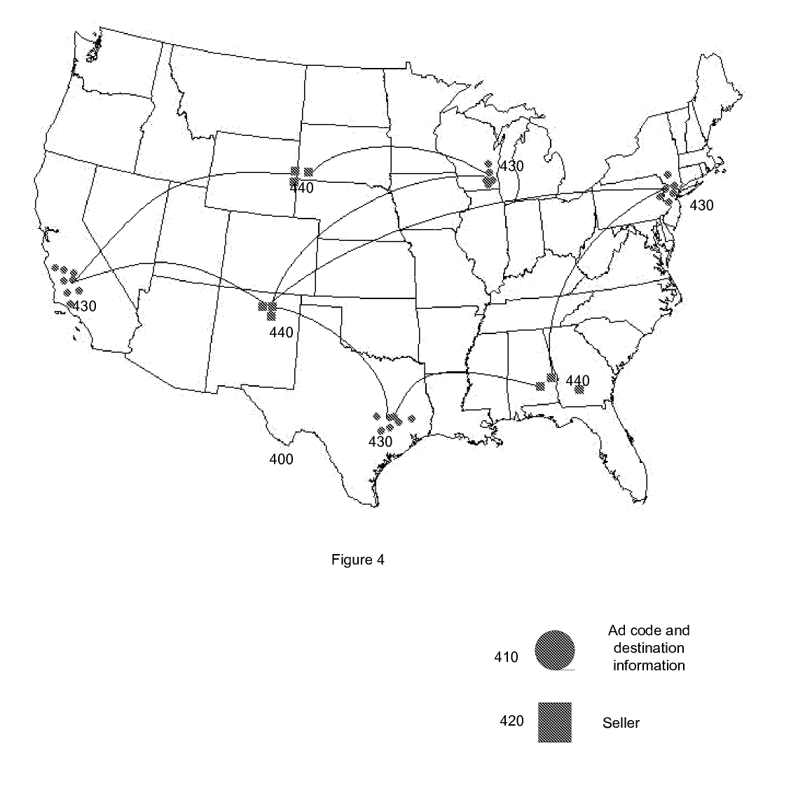

FIG. 3 shows a design 310 with different components. The components include at least an advertisement message 320 and an ad code 330. The design 310 is printed to appear on the interior of an assembled shipping container. The design may be printed such that the customer who opens the container is directed to view the advertisement. Signals to view the printed advertisements may appear on the flaps or the side panels of the shipping container. The designs 310 on each panel of the interior of the shipping container may work in conjunction with each other to provide a viewer of the advertisement with a continuous message across some or all of the interior panels of the shipping container. The advertisement printed in the interior of the shipping container may be designed such that a recipient of the shipping container who opens the container is very likely to view the entire advertisement. The advertisement message may include an advertiser logo, product image, or coupon.

The advertisement contains an advertising message originating from an advertiser. The advertiser purchases this space and provides the advertisement message to be printed on this space. The cost of the advertisement to the advertiser may be proportional to the size and/or the number of panels the design occupies. The ad code 330 is a unique identification code that identifies each individual advertisement message. The ad code 330 allows the specific advertising design to be tracked in terms of quantity, origination, and destination information, which may allow the advertiser to determine the effectiveness of a particular advertising campaign. The ad code may include a string of characters, a password, a sentence, a barcode, an embedded RF identification tag or other ways to uniquely identify an advertisement. The ad code may be printed next to (or within) an advertisement design or on a tab such that the item seller may easily locate and read the ad code.

FIG. 4 is a summary representation of particular sellers 420, the geographic location of sellers 440, the advertisement at its final destination 430, and the specific advertisement and its corresponding advertisement code 410 with respect to the advertisements' final destination 430. Map 400 is a geographic representation of the above provided information. All such information may be generated and summarized in a report for an advertiser to view and analyze. All such information allows an advertiser to determine the effectiveness of a particular advertisement and its corresponding campaign. For example, a summary of the above information lets an advertiser know exactly how many specific advertisements were sent, the final destinations of the advertisements, and also the origination of the advertisements. The printed advertisements are highly likely to be viewed by the recipients of the printed shipping containers because the containers having the printed advertisements are opened at the final destination by the recipient. Thus, the advertisers can deduce the effective viewership of their advertisements.

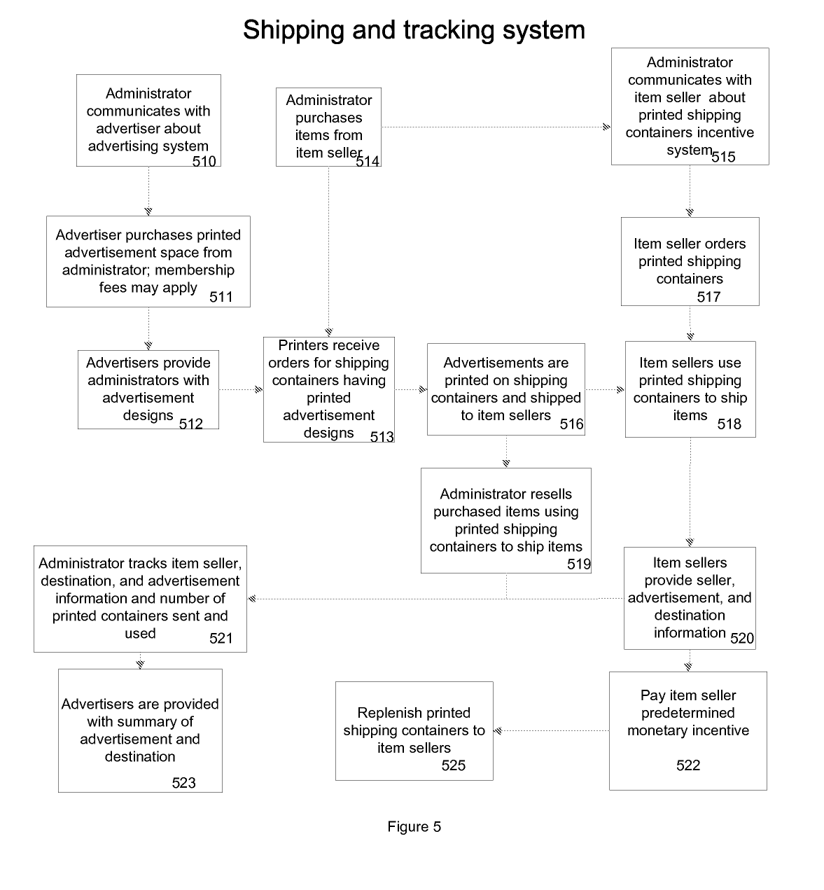

FIG. 5 is a flowchart diagram of the shipping system. There are at least three ways an administrator may initiate the system. First the administrator may communicate with an advertiser about the advertising system 5 10. An administrator may purchase items from an item seller 514. Also, an administrator may directly communicate with an item seller about the incentive system associated with using printed shipping containers 515.

Communicating with advertisers 510 includes soliciting an advertiser and informing the advertiser about the advertisement system. The advertiser is informed that the advertisement is delivered into the homes of many viewers, having the viewer actually view the advertisements at the location where they open the container, where the viewer is likely to be at an emotional state (the viewer is likely to be in an emotional state when she opens a package), and where the viewer is physically located next to a call to action (the viewer likely has a computer terminal at home when the viewer views the advertisement). Advertisers are informed that their custom advertisements are printed on the interior walls of the shipping containers. The advertisers are also informed that in order for these shipping containers to be properly used, a seller must comply with its usage rules. As a part of the usage rules, the item seller must enter destination information along with specific advertisement identification information 520. The usage rules ensure that each specific advertisement will be tracked with respect to seller information, advertisement information, and destination information.

If the usage rules are complied with, shipping containers with advertisements printed on the side walls will be delivered to customers of item sellers. Virtually all containers will be opened by the intended recipients and the advertisements that are located therein are very likely to be viewed by such recipients. The administrator maintains a central repository of such information 521. Such information will enable an advertiser to identify where each advertisements were sent to, where they were viewed, who sent the advertisements, and ultimately, the effectiveness of such advertisements and their respective campaigns 523. The advertisers may be charged on a per advertisement basis or according to a periodic membership fee 511. Also, the advertiser may be charged to have access to summary information regarding their advertisements.

Once informed of the benefits of the system, an advertiser may be advised to provide print designs to be printed in the interior of shipping containers. Then, an advertiser may purchase printed advertisement space from an administrator 511. In a preferred embodiment, an advertiser is given an advertisement generation kit. Such an advertisement kit will provide the advertiser with guidelines on generating advertisements and will also let the advertiser preview a prototype of the advertisement before sending the advertisement design out to be mass printed. Advertisers may provide custom advertisement designs 512 to either the administrator or the printer. Also, advertisers may be provided with a summary of the above information 523. In another embodiment, an advertiser may request that the administrator provide designs to the advertiser, wherein the advertiser may choose from a variety of designs generated by the administrator.

In order to get the process started with respect to creating a demand for printed shipping containers, an administrator may contact item sellers 515 and order items from them 514. Once the administrators obtain items from item sellers and advertisement requests from advertisers 511, administrators may send orders to printers to print shipping containers having advertisement designs. The orders for the printed shipping containers are sent by the administrator and received by the printers 513. The printers send the printed shipping containers to the administrator 516. The administrator may use the printed shipping containers for reselling the purchased items from the item seller 519. The administrator, in using the printed containers, collects and maintains information regarding the item seller, the destination, advertisement information, billing information, as well as inventory information. Advertisers may be provided with relevant information, such as origination of advertisements, specific advertisement information, and destination information 523, which will enable the advertisers to determine the effectiveness of their advertisements/campaigns.

Independently from, and potentially in conjunction with, ordering items from item sellers 514, an administrator may directly communicate with an item seller about using printed shipping containers and its incentive system 515. The potential incentives to an item seller in using the printed shipping containers may include monetary incentives, high quality containers, and automatic replenishment of the supply of containers. Once an item seller identifies the value of the printed shipping containers, an item seller may join by paying a membership fee or paying for the shipping of the printed shipping containers 517. The membership fee may be a recurring or a one-time charge. A portion or all of the proceeds of the program membership fee may be used to pay for the cost of shipping the unassembled containers to the item sellers. The item seller orders printed shipping containers either from the administrator or directly from a printer 517. The printers receive orders for shipping containers that have printed advertisement designs 513. The advertisements are printed on shipping containers and shipped to the item sellers 516. Once received, the item sellers may use the printed shipping containers 518 to send items to the item sellers' customers.

In one embodiment, the advertiser pays a fee to participate in sending and tracking advertisements or accessing reports. The fee that the advertiser pays may be used to pay for the cost of shipping the shipping containers to the item sellers. In another embodiment, the advertiser may pay for replacing any lost or undelivered packages.

Accordingly, item sellers provide their identification information, advertisement, and destination information to administrators 520. The administrator tracks, for example, the item sellers, destination and advertisement information as well as printed shipping container inventory information 521. Advertisers are provided with a summary of the advertisements, item sellers' information, and destination information 523. If the item sellers properly use the printed shipping containers and properly report the required information, then the item sellers will be paid a predetermined amount of money for each printed shipping container that is properly used 522. The printed shipping containers are replenished to the item sellers periodically, automatically or on a need basis 525. The administrator and/or the printers maintain printed shipping container usage information on behalf of the item sellers.

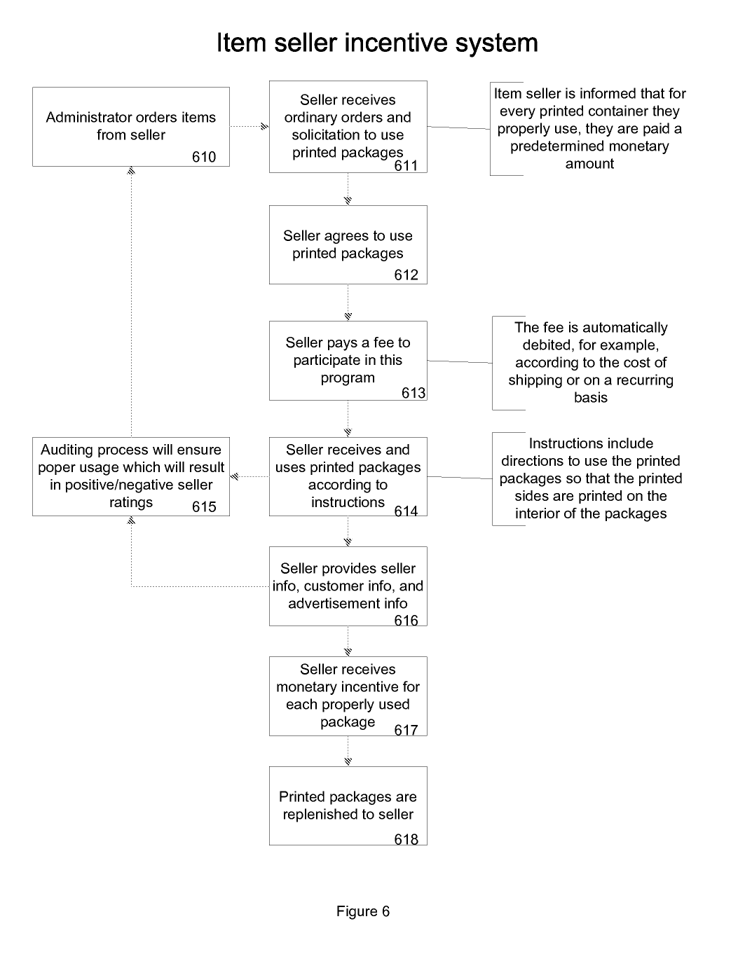

FIG. 6 shows the incentive system as presented to the item seller. A program administrator may initiate contact with item sellers by first ordering items from item sellers 610. The administrator may purchase highly resaleable products from the item sellers. Upon receiving the products from the sellers, the administrator may resell them to ordinary customers while using printed shipping containers to send the items out to the ordinary customers. This way, the administrator steps in the place of an item seller and provides the information normally required from an item seller. An item seller receives an order from an administrator and ships out the ordered items to the administrator using traditional shipping containers 611. In one embodiment, this sales transaction takes place on an online marketplace where item sellers receive feedback. The feedback may be based on the delivery quality and timeliness of the shipped item. Here, within a feedback process, an administrator may solicit and inform the item sellers of the benefits of using printed shipping containers 611. Namely, the benefits include, for example, a predetermined monetary incentive for every printed shipping container that the item seller properly uses 617, high quality shipping containers (as opposed to ad hoc taped bubble wrapped containers that is conventionally used), and the convenience of having shipping containers automatically restocked. In one embodiment, a seller may receive a positive rating if the seller chooses to use the printed shipping containers to ship their items. Once advised of the monetary and superior shipping containers an item seller may agree to use the printed shipping containers 612.

The item sellers are advised that they must pay a membership fee or a fee to cover the costs associated with shipping the printed containers to the item sellers 613. This membership fee may be a monthly recurring charge, a scaled charge based on actual usage or a charge directly related to the cost associated with shipping the printed containers to the item sellers. The item sellers may be required to enter into an agreement wherein the item seller agrees to order and use a certain amount of boxes for a fixed period of time, for example, 5000 boxes per any three month period. The amount of money charged to the item seller may be a recurring fee related to the actual usage of the number of printed shipping containers. The amount of money charged to the item seller may be a recurring or non-recurring flat fee.

Once the seller pays the program fee, the seller receives the printed shipping containers 614. In one embodiment, the printed shipping containers may arrive flattened and unassembled. An instruction sheet, along with the package of shipping containers, may be provided to the item sellers. The instructions inform the item seller to use the shipping containers a certain way 614. The item seller is instructed to assemble the container in such a way so the printed side appears on the interior of the shipping container. The instructions may also tell the item seller not to obstruct the printed material or to use the container in a way that prevents an intended recipient from viewing the printed material. The instructions also tell the item sellers to provide certain information to the administrator 616. For example, in order for the item seller to receive the monetary incentive, the item seller must register at the administrator's website. The website contains a database that tracks and maintains client information. In a preferred embodiment, when fully registered, an item seller is required to enter destination information and item information. Although not prompted, seller information may be collected and stored at a registration step. The seller information may be gathered and used to identify where a particular advertisement originates.

In one embodiment, an auditing process may be implemented to ensure that the item sellers are properly using the boxes, and providing the right information to the administrator 615. As in an initial contacting phase of the program, the administrators may order highly saleable items from the item sellers. The administrators may audit the proper usage of the shipping containers by first-hand observation. When the administrators receive the items they ordered from the item sellers, the shipping container and the way they were assembled can be easily observed. Also, the administrators may observe whether the interior printed materials are improperly obstructed. Also, the administrators may observe the item sellers' compliance with the program through the database. Because the administrator knows its own location information and the printed shipping container inventory of the item seller, the administrator can easily check to see whether the item seller has entered the proper required information into the administrator's database. Punitive measure for improper usage of the printed shipping containers include, for example, contacting and querying the item sellers directly; giving negative ratings to the item sellers, or discontinuing the item sellers' membership to the program. The item seller ordinarily receives a predetermined monetary amount for every shipping container that the item seller properly uses 617. Also, the inventories of the shipping containers are tracked such that printed shipping containers are automatically restocked to item sellers that have predetermined minimum quantities 618. Item sellers may manage their own printed shipping container inventory and specifically request for additional containers.

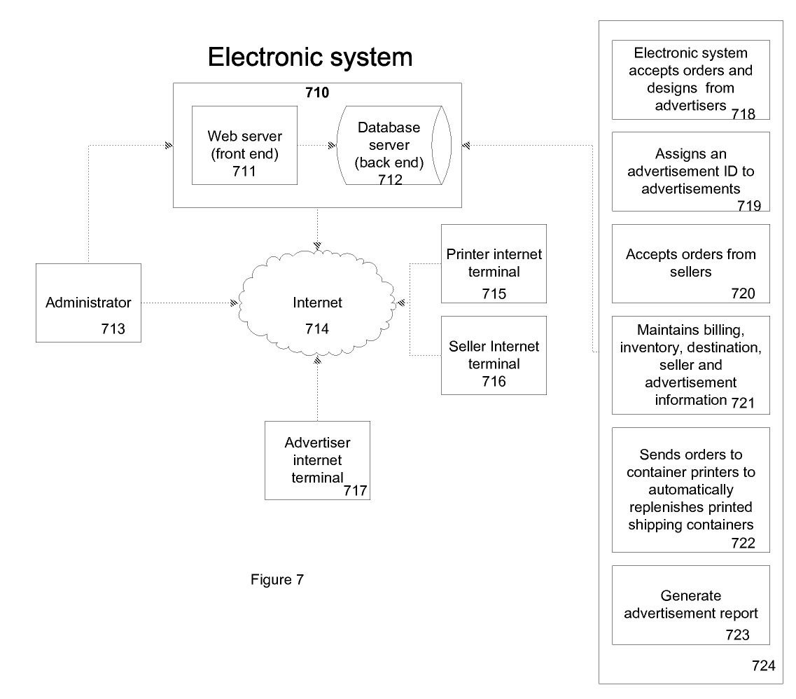

FIG. 7 is a hardware representation of the program administration's electronic system 710. An Internet enabled web server 711 is connected to a database 712. The web server is responsible for interfacing to the administrator 713, the advertiser 717, the printers 715 and item sellers 716. The printer 715, advertiser 717, administrator 713 and item sellers 716 may be connected to the electronic system 710 via an Internet connection 714. The administrator 713 may have direct access to the electronic system 710. The administrator 713 may access the Internet enabled web server 711 through a web browser. The administrator 713 may include a CPU, computer storage, and program executable code stored on the computer storage. The web browser, for example, may be a part of a software package installed on a personal computer.

The electronic system 710 may contain logical components 724 that control the interactions between the administrator, printers, advertisers and item sellers. For example, the electronic system 710 may accept print orders from administrators, advertisers, or item sellers 718. The electronic system 710 may also accept and store print designs from advertisers.

Once the electronic system accepts an advertising design from an advertiser 718, the electronic system may automatically assign a unique identification code to the advertising design 719. The database 712 in the electronic system 710 stores advertiser information, administrator information, printer information, and item seller information. Advertiser information may include, but is not limited to, advertiser branding information, address, contact information, billing and inventory information, membership and rewards programs, print designs, logos, destination information regarding where the advertisements were sent, and also the senders of such advertisements. Printer information may include, but is not limited to, physical addresses, contact information, price schedules, shipment histories and queues, successful and failed orders and customer feedback and comments. Item seller information may include, but is not limited to, item inventory, order history and scheduling, billing, rewards and incentive information, feedback, ratings system and monitoring data. Administrator information may include account management information and all of the above-mentioned information.

The electronic system 710 may initiate and send orders for printed shipping containers to printers 722. This automatic ordering mechanism may happen when the item seller first joins the program, when an administrator sends a request on behalf of an advertiser or item seller, or when the item seller sends a specific request for printed containers through the seller's Internet terminal 716 to the printer 715. The electronic system may accept an incoming order for printed shipping containers 720. The electronic system may also coordinate and schedule a monthly recurring ordering and calendar so that item sellers may receive a steady stream of printed shipping containers. In a preferred embodiment, the electronic system 710 maintains billing, inventory, destination, and advertisement information 721 such that administrators, advertisers, printers and item sellers may access information and manage/administer their accounts.

The electronic system 710 has the capability of generating an advertisement report 723 for the advertiser 717. Information that can be included in the advertisement report 723 include, but is not limited to, specific advertisement information 410, sender information 420, and destination information 430. Such results may be plotted on a map 400, see for example, see FIG. 4.

The web server 711 is responsible for delivering a graphical user interface to the administrator such that the administrator can, for example, monitor order status, inventories and billing transactions. The graphical user interface allows the administrator to respond to inquiries from the printers, advertisers or item sellers. Typically, a web server 711 is hosted at an Internet hosting service provider and allows any party (administrator, printer, advertiser or item seller) to access its services.

1. A method for sending and tracking printed advertisements, the method including:
receiving an advertisement order to disseminate an advertisement message from an advertiser;
sending a printing order to print a design on a wall of a shipping container,
wherein the design includes the advertisement message and a unique identification code linked to the advertisement message;
sending the shipping container to an item seller;
instructing the item seller to configure the shipping container such that the design appears on an inside wall of the shipping container, and further instructing the item seller to submit destination information, the unique identification code, and origination information of the shipping container;
sending an item to a destination using the shipping container;
receiving the destination information, the unique identification code, and the origination information from the item seller;
compensating the item seller upon receiving the destination information, the unique identification code, and the origination information submitted by the item seller; and
providing a report of at least the destination information, the advertisement message, and the origination information to the advertiser.

2. The method of claim 1 further including:
ordering an item from an item seller;
reselling the ordered item;
sending the ordered item using the shipping container; and
further receiving destination information, the unique identification code, and origination information of the shipping container containing the ordered item.

3. The method of claim 1 wherein:
the item seller is compensated a predetermined amount of money for every printed shipping container the item seller uses as instructed.

4. The method of claim 1 further including:
informing an item seller of incentives for using the shipping container,
wherein the incentives include at least one of money, superior container quality, and convenience; and
providing a positive rating to the item seller if the item seller agrees to use the shipping container.

5. The method of claim 1 wherein:
the report containing the destination information, the advertisement message, and the origination information is presented in a geographical map.

6. The method of claim 1 further including:
tracking an inventory of shipping containers; and
replenishing the inventory of shipping containers to the item seller once the inventory of shipping containers reaches a certain amount.

7. The method of claim 1 further including:
charging the item seller a fee to receive the shipping container.

8. The method of claim 4 further including:
auditing the item seller,
wherein the auditing includes:
verifying the destination information, the unique identification code, and the origination information submitted by the item seller, and
further verifying that the item seller configured the shipping container as instructed.

9. The method of claim 8 further including:
providing a positive rating to the item seller if the item seller submitted the destination information, the unique identification code, and the origination information and configured the printed shipping container as instructed; and
providing a negative rating to the item seller if the item seller submitted information or configured the printed shipping container not as instructed.

10. The method of claim 5 further including:
charging the advertiser a fee to access the report.

11. A system for sending and tracking printed advertisements, the system including:
a receiving section for receiving an advertisement order to disseminate an advertisement message from an advertiser;
a sending section for sending a printing order to print a design on a wall of a shipping container,
wherein the design includes the advertisement message and a unique identification code linked to the advertisement message, and
wherein the sending section further sends the shipping container to an item seller;
an instructing section for instructing the item seller to configure the shipping container such that the design appears on an inside wall of the shipping container, and further instructing the item seller to submit destination information, the unique identification code, and origination information of the shipping container;
the receiving section further receiving the destination information, the unique identification code, and the origination information from the item seller; a compensating section for paying the item seller upon receiving the destination information, the unique identification code, and the origination information submitted by the item seller; and
a reporting section for providing a report of at least the destination information, the advertisement message, and the origination information to the advertiser.

12. The system of claim 11 further including:
an ordering section for ordering an item from an item seller;
a selling section for reselling the ordered item;
the sending section further sends the ordered item using the shipping container; and
the receiving section further receives destination information, the unique identification code, and origination information of the shipping container containing the ordered item.

13. The system of claim 11 wherein:
the compensating section pays the item seller a predetermined amount of money for every printed shipping container the item seller uses as instructed.

14. The system of claim 11 further including:
an informing section for informing an item seller of incentives for using the shipping container,
wherein the incentives include at least one of money, superior container quality, and convenience; and
a rating section for providing a positive rating to the item seller if the item seller agrees to use the shipping container.

15. The system of claim 11 wherein:
the reporting section provides the report containing the destination information, the advertisement message, and origination the information presented in a geographical map.

16. The system of claim 11 further including:
a tracking section for tracking an inventory of shipping containers; and
a replenishing section for replenishing the inventory of shipping containers to the item seller once the inventory of shipping containers reaches a certain amount.

17. The system of claim 11 further including:
a charging section for charging the item seller a fee to receive the shipping container.

18. The system of claim 14 further including:
an auditing section for auditing the item seller,
wherein the auditing includes:
a verifying section for verifying the destination information, the unique identification code, and the origination information of the shipping container submitted by the item seller, and
further verifying that the item seller configured the shipping container as instructed.

19. The system of claim 18 wherein:
the rating section further providing a positive rating to the item seller if the item seller submitted the destination information, the unique identification code, and the origination information and configured the printed shipping container as instructed; and
the rating section further providing a negative rating to the item seller if the item seller submitted the destination information, the unique identification code, and the origination information or configured the printed shipping container not as instructed.

20. A computer readable medium containing instructions causing a computer to:
receive an advertisement order to disseminate an advertisement message from an advertiser;
send a printing order to print a design on a wall of a shipping container,
wherein the design includes the advertisement message and a unique identification code linked to the advertisement message;
send the shipping container to an item seller;
instruct the item seller to configure the shipping container such that the design appears on an inside wall of the shipping container, and further instruct the item seller to submit destination information, the unique identification code, and origination information of the shipping container;
send an item to a destination using the shipping container;
receive the destination information, the unique identification code, and the origination information from the item seller;
compensate the item seller upon receiving the destination information, the unique identification code, and the origination information submitted by the item seller; and
provide a report of at least the destination information, the advertisement message, and the origination information to the advertiser.
